(19) United States
(12) Patent Application Publication
(10) Pub. No.: US 2025/0227004 A1
(43) Pub. Date: Jul. 10, 2025

(54) METHOD, SYSTEM, AND STORAGE MEDIUM FOR IMPLEMENTING REMOTE CONFERENCE

(71) Applicant: HybriU Inc., Dover, DE (US)

(72) Inventor: Jin HUANG, Lynnwood, WA (US)

(21) Appl. No.: 19/011,197

(22) Filed: Jan. 6, 2025

(30) Foreign Application Priority Data
Jan. 9, 2024 (CN) 2024100348969

(51) Int. Cl. H04L 12/18

(52) U.S. Cl. CPC H04L 12/1822; H04L 12/1831

(57) ABSTRACT

The present application provides a method, a system and a storage medium for implementing remote conference. The method comprises: when the remote conference is in the mode of live streamer only, collecting an image video signal of the live streamer and an audio information of the live streamer and sending them to a remote output device for output after processing; when the remote conference is in the mode of live streamer plus shared content, collecting and processing an image video information of the live streamer, a video information of the live stream content and the audio information of the live streamer; and transmitting to a local display device for display or a remote output device for output.

### FIELD OF THE INVENTION

The present application relates to the field of network communications, and more particularly, to a method, a system, and a storage medium for implementing remote conference.

### BACKGROUND OF THE INVENTION

Remote conferencing is a kind of multimedia communication technology that enables people in different places to realize communication in real-time, visual and interactive ways through certain transmission medium. It can distribute various information such as static/dynamic images, voice, text, pictures and the like of the characters to the terminal devices of each user through various existing electrical communication transmission media, so that geographically dispersed users can exchange information through various means such as graphic and sound, making participants feel like they are immersed in meetings in the same venue. With the development of remote conferencing, application scenarios are becoming more and more abundant, and the common one is the online and offline synchronous conferencing. However, existing conference systems display the same content both offline and online, offering poor experience to on-site participants. Therefore, it is necessary to provide a method for implementing remote conference that allows on-site and remote participants to view different screen content of the conference.

### SUMMARY OF THE INVENTION

The present application is made in view of at least one of the above-mentioned technical problems existing in the prior art. In a first aspect of the present application, there is provided a method for implementing remote conference, comprising:
when the remote conference is in the mode of live streamer only, collecting an image video signal of the live streamer and an audio information of the live streamer and sending them to a remote output device for output after processing;
when the remote conference is in the mode of live streamer plus shared content, collecting and processing the image video signal of the live streamer, a video information of the live stream content and the audio information of the live streamer; transmitting the video information of the live stream content to a local display device for display; and sending the processed image video information of the live streamer, the processed video information of the live stream content and the processed audio information of the live streamer to a remote output device for output.

In some embodiments, the method further comprises:
when the remote conference is in the mode of live streamer plus shared content, the step of collecting and processing the image video information of the live streamer comprises: when the image video signal of the live streamer contains a close-up image of the live streamer, obtaining the close-up image video signal of the live streamer as the processed image video signal of the live streamer; when the image video signal of the live streamer contains an image but no close-up image of the live streamer, taking the image video signal of the live streamer as the processed image video signal of the live streamer.

In some embodiments, the method further comprises:
when the remote conference is in the mode of live streamer only, the step of collecting and analyzing the image video information of the live streamer comprises: when there is no portrait image in the image video of the live streamer, sending a default image to replace the image video of the live streamer;
when the remote conference is in the mode of live streamer plus shared content, the step of collecting and analyzing the image video information of the live streamer comprises: when there is no portrait image in the image video of the live streamer, sending a default content to replace the image video of the live streamer.

In some embodiments, the method further comprises:
recording the conference video displayed at the remote end in real time, and sending the recorded conference video to a cloud server for storage.

In some embodiments, the method further comprises:
when the switching condition is satisfied, switching the remote conference mode to a mode corresponding to the switching condition.

In some embodiments, the remote conference mode further comprises an interaction mode, and when the condition for the interaction mode is satisfied, a remote participant can interact with the live streamer.

In some embodiments, the method further comprises:
when receiving a request for creating a live stream sent by a participant, responding to the request.

In some embodiments, the method further comprises:
when the condition for ending a remote conference is satisfied, ending the current remote conference;
wherein, the condition for ending a course comprises coming to a scheduled end time of live stream or receiving a course ending instruction.

In some embodiments, the method further comprises:
based on the settings of the local playing device and the remote playing device, the collected original audio signal of the remote conference is converted into target language subtitles and displayed.

In a second aspect of the embodiments of the present application, there is provided a system for implementing remote conference, comprising: a multimedia acquisition module, a processing control module, and a WIFI module and an antenna interface which are arranged integrally and locally;
the multimedia module is configured to collect a first multimedia signal both on-site and from remote in real time and transmit the first multimedia signal to the processing control module, wherein the first multimedia signal both on-site and from remote at least comprises a video signal of the live streamer's courseware, a video signal of the live streamer's live stream image, an audio signal of the live streamer and a video signal of the image of on-site students;
the WIFI module and the antenna interface are configured to connect to a wireless controller for receiving an operation instruction transmitted from the wireless controller and sending the operation instruction to the processing control module;
the processing control module is configured to receive and process the first multimedia signal to obtain a second multimedia signal, and send the processed second multimedia signal to the multimedia module; and
the multimedia module further comprises at least one set of multimedia output interfaces, configured to connect to, and transmit the processed second multimedia signal received from the processing control module to, a multimedia display device arranged locally and/or remotely for display;
wherein, the processing control module is configured to:
when the remote conference is in the mode of live streamer only, collecting an image video signal of the live streamer and an audio information of the live streamer and sending them to a remote output device for output after processing;
when the remote conference is in the mode of live streamer plus shared content, collect and process the image video signal of the live streamer, a video information of the live stream content and the audio information of the live streamer; transmit the video information of the live stream content to a local display device for display; and send the processed image video information of the live streamer, the processed video information of the live stream content and the processed audio information of the live streamer to a remote output device for output.

In a third aspect of the embodiments of the present application, there is provided a storage medium, having stored thereon a computer program, which, when executed by a processor, causes the processor to carry out the method for implementing remote conference as described above.

The method for implementing remote conference in the embodiments of the present application collects an image video signal of the live streamer and an audio information of the live streamer and sends them to a remote output device for output after processing, when in the mode of live streamer only, and collects and processes the image video information of the live streamer, a video information of the live stream content and the audio information of the live streamer, and then transmits to a local display device for display or a remote output device for output, when the remote conference is in the mode of live streamer plus shared content, so that the embodiments of the present application have realized the display of different live stream screen content in different modes.

### BRIEF DESCRIPTION OF THE DRAWINGS

In order to more clearly explain the technical schemes in the embodiments of the present application, the following will briefly introduce the drawings needed in the description of the embodiments. Obviously, the drawings in the following description are only some embodiments of the present application. Those of ordinary skill in the art can also obtain other drawings based on these drawings without any creative effort.

FIG. 1 illustrates a schematic flow chart of the method for implementing remote conference according to an embodiment of the present application;

FIG. 2 illustrates a schematic flow chart of the control logic in the mode of teacher plus teaching computer screen according to an embodiment of the present application;

FIG. 3 illustrates a schematic flow chart of the control logic in the mode of teacher plus cloud file according to an embodiment of the present application;

FIG. 4 illustrates a schematic flow chart of the control logic in the mode of teacher only according to an embodiment of the present application;

FIG. 5 illustrates a schematic flow chart of the control logic of the end of live stream according to an embodiment of the present application;

FIG. 6 illustrates a schematic flow chart of a system for implementing remote conference according to an embodiment of the present application;

FIG. 7 illustrates a schematic diagram of an application scenario of a system for implementing remote conference according to an embodiment of the present application; and

FIG. 8 illustrates a schematic diagram of another application scenario of a system for implementing remote conference according to an embodiment of the present application.

### DETAILED DESCRIPTION OF THE PREFERRED EMBODIMENTS

In order to enable those skilled in the art to better understand the technical schemes of the embodiments of the present application, the following will clearly and completely describe the technical schemes in the embodiments of the present application with reference to the accompanying drawings in the embodiments of the present application. Obviously, the described embodiments are only a part of the embodiments of the present application, rather than all the embodiments. Based on the embodiments in the present application, all the other embodiments obtained by persons of ordinary skill in the art without making creative efforts fall within the scope of the present application.

Based on at least one of the above technical problems, the present application provides a method for implementing remote conference, comprising: when the remote conference is in the mode of live streamer only, collecting an image video signal of the live streamer and an audio information of the live streamer and sending them to a remote output device for output after processing; when the remote conference is in the mode of live streamer plus shared content, collecting and processing the image video information of the live streamer, a video information of the live stream content and the audio information of the live streamer; transmitting the video information of the live stream content to a local display device for display; and sending the processed image video information of the live streamer, the processed video information of the live stream content and the processed audio information of the live streamer to a remote output device for output. The method for implementing remote conference in the embodiments of the present application collects an image video signal of the live streamer and an audio information of the live streamer and sends them to a remote output device for output after processing, when in the mode of live streamer only, and collects and processes the image video information of the live streamer, a video information of the live stream content and the audio information of the live streamer, and then transmits to a local display device for display or a remote output device for output, when the remote conference is in the mode of live streamer plus shared content, so that the embodiments of the present application have realized the display of different live stream screen content in different modes.

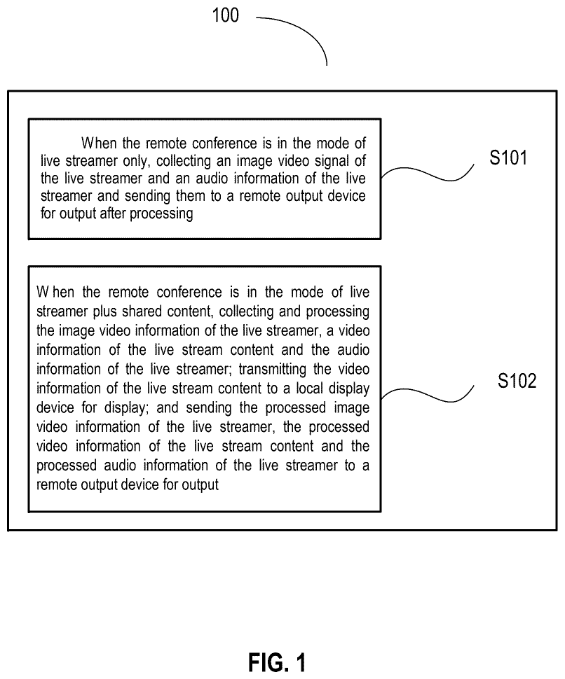

FIG. 1 illustrates a schematic flow chart of the method for implementing remote conference according to an embodiment of the present application. As shown in FIG. 1, the method for implementing remote conference 100 according to an embodiment of the present application may comprise the following steps S101 and S102:

In Step S101, when the remote conference is in the mode of live streamer only, an image video signal of the live streamer and an audio information of the live streamer are collected and sent to a remote output device for output after processing. The image video of the live streamer is not displayed on the local display device.

In Step S102, when the remote conference is in the mode of live streamer plus shared content, the image video signal of the live streamer, a video information of the live stream content and the audio information of the live streamer are collected and processed; the video information of the live stream content is transmitted to a local display device for display; and the processed image video information of the live streamer, the processed video information of the live stream content and the processed audio information of the live streamer are sent to a remote output device for output. The local display device and the remote output device present different content. If the live streamer broadcasts locally, there is no need to display the image video of the live streamer, so the shared content screen will be displayed on the local display device. The remote output device outputs an image video of the live streamer and a shared content screen.

In one embodiment of the present application, the method further comprises:
when the remote conference is in the mode of live streamer plus shared content, the step of collecting and processing the image video information of the live streamer comprises: when the image video signal of the live streamer contains a close-up image of the live streamer, obtaining the close-up image video signal of the live streamer as the processed image video signal of the live streamer; when the image video signal of the live streamer contains an image but no close-up image of the live streamer, taking the image video signal of the live streamer as the processed image video signal of the live streamer.

Wherein, when a person and his/her face are recognized, and the face is centered in the screen, the image video signal of the live streamer is considered to contain the image of the live streamer.

In one embodiment of the present application, the method further comprises:
when the remote conference is in the mode of live streamer only, the step of collecting and analyzing the image video information of the live streamer comprises: when there is no portrait image in the image video of the live streamer, sending a default image to replace the image video of the live streamer;
when the remote conference is in the mode of live streamer plus shared content, the step of collecting and analyzing the image video information of the live streamer comprises: when there is no portrait image in the image video of the live streamer, sending a default content such as image to replace the image video of the live streamer.

In one embodiment of the present application, the method further comprises: recording the conference video displayed at the remote end in real time, and sending the recorded conference video to a cloud server for storage.

The embodiments of the present application can be applied to not only offline and online remote synchronous teaching, but also offline and online remote synchronous conference, etc. The embodiments of the present application are described below with examples of online and offline remote teaching.

In the embodiments of the present application, after audio and video are collected and before they are played locally or sent to a cloud server, the video image can be processed by means of, for example, cutting, splicing, de-contextualization, beautifying, denoising, speech recognition, synchronization and fusion, and performed the following corresponding inputs according to the type of the processing result;
(1) Video (or content) input function, such as screen of local teaching device, several camera screens of a local teacher, several camera screens of local students, several camera screens of a remote teacher and guests, several camera screens of remote students, cloud video, cloud PPT, cloud PDF, cloud MS WORD file, and whiteboard drawing board;
(2) Audio input function such as several audios of a local teacher, several audios of local students, several audios of a remote teacher and guests, several audios of remote students, cloud audio file, etc.;
(3) Network communication feature such as teacher-controlled device, chat text, etc.

By the processing described above, a live or recording course available for local or online use can be generated.

The corresponding outputs are described below for the three inputs described above. In a first example, the video output function may be implemented via a local teaching screen (e.g. teaching screen), a local auxiliary screen for teacher (e.g. head-up display), a remote student screen (e.g. laptop, desktop, PAD, cell phone, etc.).

In one example, different teaching contents may be displayed according to different roles in class.
(1) Students in Local Classroom: view the contents displayed on the local teaching screen (teaching screen): cloud files/teaching computer, and images of students participating in the interaction.
(2) Teacher in Local Classroom: view the contents displayed on the local auxiliary screen for teacher (head-up screen): local teaching device screen (such as teaching computer), cloud files, online students, chat room text, live stream data, online student screen, PPT notes, etc.
(3) Teacher, Guests and Students from Remote: view the contents displayed on the remote student screen (laptop, desktop, PAD, mobile phone, etc.): teacher screen+PPT screen/whiteboard/cloud files/local teaching device screen (such as teaching computer), etc.

In a second example, the audio output function may be implemented by synchronized output to local classroom, and remote teacher, guests and students. Furthermore, the embodiments of the present application can support the recognition of at least 80 different languages and the conversion into real-time subtitles, enabling inter-conversion between languages.

In a third example, the Internet communication function may be implemented by two-way transmission of local and remote signals.

In one embodiment of the present application, the method further comprises:
when the switching condition is satisfied, switching the remote conference mode to a mode corresponding to the switching condition. For example, the mode of live streamer only and the mode of live streamer plus shared content may be switched in real time according to the switching condition, or by active control of the live streamer.

In one embodiment of the present application, the remote conference mode further comprises an interaction mode, and when the condition for the interaction mode is satisfied, a remote participant can interact with the live streamer.

In the embodiment of the present application, the teaching control device can, through this function, control the display content, switch layout, create live stream, join live stream, switch to teaching mode/discussion mode, operate cloud files (PPT, PDF, video and audio), translate PPT documents, write and draw on a whiteboard, and change the role of an online student into an interactive guest to have audio and video interaction with on-site teacher or students.

In one embodiment of the present application, the method further comprises:
when receiving a request for creating a live stream sent by a participant, responding to the request.

In one embodiment of the present application, the method further comprises:
when the condition for ending a remote conference is satisfied, ending the current remote conference;
wherein, the condition for ending a course comprises coming to a scheduled end time of live stream or receiving a course ending instruction. For example, if the scheduled live stream time is 9:00 to 10:00, the live stream course will be automatically ended when it comes to 10:00. Alternatively, the live stream may be actively terminated by the live streamer.

For another example, the method may further comprise the step of automatically ending the conference, that is, if the teacher leaves the classroom and forgets to close the course, the system may automatically detect whether there is any person or sound in the classroom at the scheduled time, and end the live stream if none is detected.

In one embodiment of the present application, the method further comprises:
based on the settings of the local playing device and the remote playing device, the collected original audio signal of the remote conference is converted into target language subtitles and displayed on the screen of a display terminal. The embodiments of the present application can support the recognition of at least 80 different languages and online real-time inter-conversion, such as inter-conversion between Chinese and English, or Chinese-to-English conversion, English-to-French conversion, French-to-German conversion, etc. to break language communication barriers.

The following embodiments are described with examples of online and offline remote teaching. Accordingly, the live streamer may in this case be a teacher. In a live stream, there are three modes available to the teacher, namely, the mode of teacher plus manuscript, the mode of teacher plus cloud file and the panoramic mode of teacher, and the layout can be automatically switched according to different teaching modes selected by the teacher and the state of the teacher and the display device (such as an HDMI device).

As an embodiment of the present application, the mode of live streamer plus shared content is a live streamer plus teaching computer screen mode, and/or a live streamer plus cloud file mode.

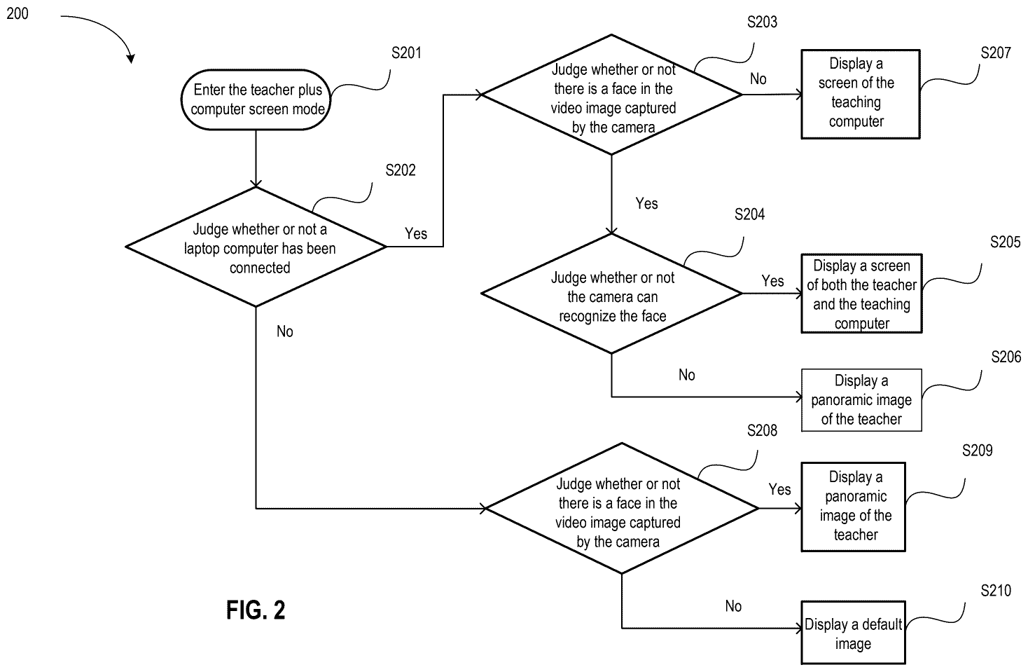

As shown in FIG. 2, this is a logic schematic flow chart of controlling a remote output device to output content in a teacher as live streamer plus computer screen mode according to an embodiment of the present application. The control logic 200 in the teacher plus computer screen mode according to the embodiment of the present application may comprise the following steps S201, S202, S203, S204, S205, S206, S207, S208, S209 and S210:
In Step S201, the teacher plus computer screen mode is entered;
In Step S202, it is judged whether or not a laptop computer has been connected; if so, proceeding to Step S203, otherwise, proceeding to Step S208;
In Step S203, it is judged whether or not there is a face in the video image captured by the camera; if so, proceeding to Step S204, otherwise, proceeding to Step S207;
In Step S204, it is judged whether or not the camera can recognize the face; if so, proceeding to Step S205, otherwise, proceeding to Step S206;
In Step S205, a screen of both the teacher and the teaching computer is displayed;
In Step S206, a panoramic image of the teacher is displayed;
In Step S207, a screen of the teaching computer is displayed;
In Step S208, it is judged whether or not there is a face in the video image captured by the camera; if so, proceeding to Step S209, otherwise, proceeding to Step S210;
In Step S209, a panoramic image of the teacher is displayed;
In Step S210, a default image is displayed.

In the panoramic mode of teacher in the embodiment of the present application, the display interface can in this case switch to the corresponding layout according to the acquired video images.

For example, it is possible for the display interface to display an image of the teacher and a laptop computer desktop image when the laptop computer of the teacher is connected and a face image of the teacher can be captured. If only the laptop computer is connected, but the face image of the teacher cannot be captured, then only the laptop desktop video image will be displayed. When the web camera can capture the image of the teacher, a panoramic image of the teacher will be displayed, and when the image of the teacher cannot be captured and the laptop computer of the teacher is not connected, a default image will be displayed. Furthermore, when displaying the panoramic image of the teacher, the image needs to be continuously displayed for a preset time, and the displayed image needs to be a front face image, and the face is displayed centrally in the display interface.

It should be noted that a switch condition will be checked at preset time intervals to see if a layout change is needed. For example, it is possible for the display interface to display an image of the teacher and a laptop computer desktop image when the laptop computer of the teacher is connected and a face image of the teacher can be captured. If, after 10 seconds, the camera cannot capture the face image of the teacher, then only the laptop computer desktop image will be displayed; and a default image will be displayed if the teacher's laptop computer cannot be connected and the teacher's face image cannot be acquired after 10 further seconds; and the image of the teacher and the laptop desktop image will continue to be displayed, if the teacher's laptop is re-connected and the teacher's face image can be captured after another 10 seconds.

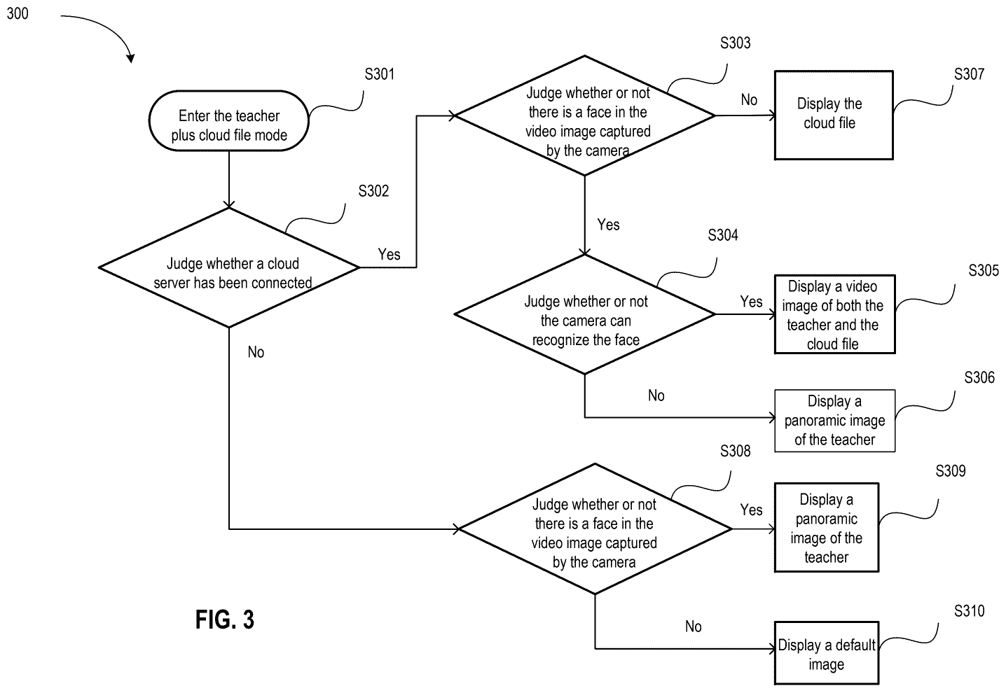

As shown in FIG. 3, this is a logic schematic flow chart of controlling a remote output device to output content in a teacher as live streamer plus cloud file mode according to an embodiment of the present application. The control logic 300 in the teacher plus cloud file mode according to the embodiment of the present application may comprise the following steps S301, S302, S303, S304, S305, S306, S307, S308, S309 and S310:
In Step S301, the teacher plus cloud file mode is entered;
In Step S302, it is judged whether a cloud server has been connected; if so, proceeding to Step S303, otherwise, proceeding to Step S308;
In Step S303, it is judged whether or not there is a face in the video image captured by the camera; if so, proceeding to Step S304, otherwise, proceeding to Step S307;
In Step S304, it is judged whether or not the camera can recognize the face; if so, proceeding to Step S305, otherwise, proceeding to Step S306;
In Step S305, a video image of both the teacher and the cloud file is displayed;
In Step S306, a panoramic image of the teacher is displayed;
In Step S307, the cloud file is displayed;
In Step S308, it is judged whether or not there is a face in the video image captured by the camera; if so, proceeding to Step S309, otherwise, proceeding to Step S310;
In Step S309, a panoramic image of the teacher is displayed;
In Step S310, a default image is displayed.

The embodiment of the present application displays a video image of the teacher and the cloud file in the panoramic mode of teacher and in the mode of teacher plus cloud file, when the cloud file is played and the camera can capture his/her face.

Furthermore, when the web camera can capture the image of the teacher, a panoramic image of the teacher will be displayed, and when the image of the teacher cannot be captured and the cloud file cannot be obtained, a default image will be displayed. It should be noted that, when displaying the panoramic image of the teacher, the image needs to be continuously displayed for a preset time, and the displayed image needs to be a front face image, and the face is displayed centrally in the display interface.

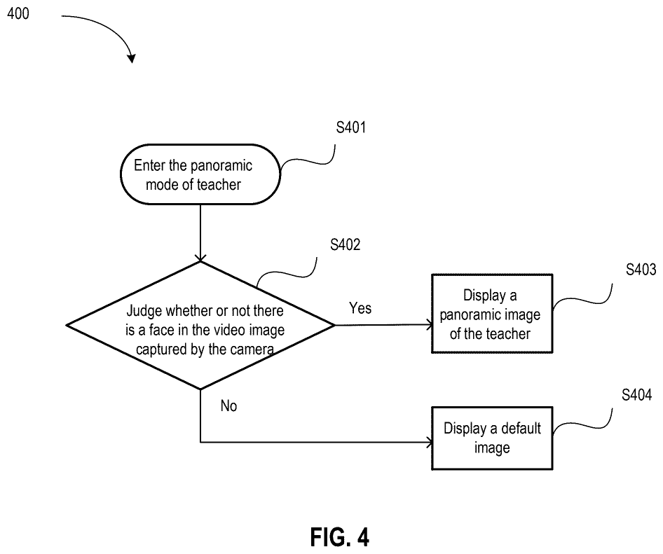

In one embodiment of the present application, it is possible to select the panoramic mode of teacher, as shown in FIG. 4, which is a schematic flow chart controlling a remote output device to output content in a panoramic mode of teacher according to an embodiment of the present application. The control logic 400 in the panoramic mode of teacher according to the embodiment of the present application may comprise the following steps S401, S402, S403 and S404:
In Step S401, the panoramic mode of teacher is entered;
In Step S402, it is judged whether or not there is a face in the video image captured by the camera; if so, proceeding to Step S403, otherwise, proceeding to Step S404;
In Step S403, a panoramic image of the teacher is displayed;
In Step S404, a default image is displayed.

In the panoramic mode of teacher according to the embodiment of the present application, when the web camera can capture the image of the teacher, a panoramic image of the teacher will be displayed, and when the image of the teacher cannot be captured, a default image will be displayed.

Furthermore, when capturing an image of the teacher, the embodiment of the present application can also perform image processing operations such as character beautifying, background changing, and background blurring. Face data may also be entered to bind the face with a system account, allowing such subsequent operations as dynamic tracking and intelligent cutting of the face.

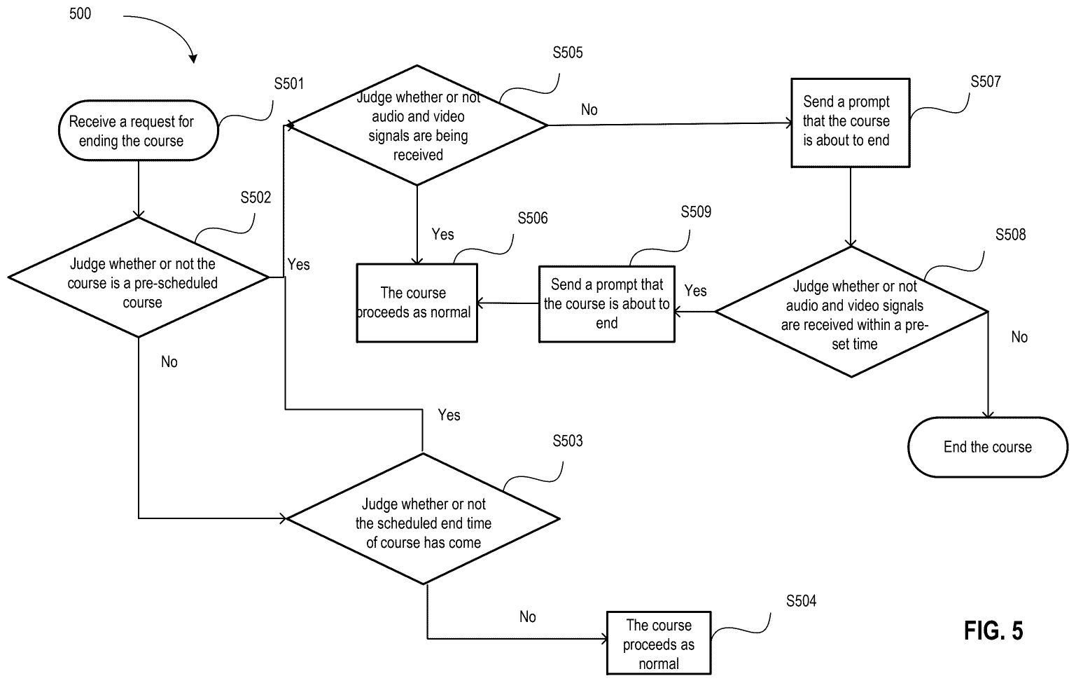

As shown in FIG. 5, this is a schematic flow chart of the control logic of the end of live stream according to an embodiment of the present application. The control logic 500 for the end of live stream according to an embodiment of the present application may comprise the following steps S501, S502, S503, S504, S505, S506, S507, S508 and S509:
In Step S501, a request for ending the course is received;
In Step S502, it is judged whether or not the course is a pre-scheduled course, and if so, proceeding to Step S503, otherwise, proceeding to Step S505;
In Step S503, it is judged whether or not the scheduled end time of course has come; if so, proceeding to Step S504, otherwise, proceeding to Step S505;
In Step S504, the course proceeds as normal;
In Step S505, it is judged whether or not audio and video signals are being received; if so, proceeding to Step S506, otherwise, proceeding to Step S507;
In Step S506, the course proceeds as normal; returning to Step S504;
In Step S507, a prompt that the course is about to end is sent;
In Step S508, it is judged whether or not audio and video signals are received within a pre-set time; if so, proceeding to Step S508, otherwise ending the course;
In Step S509, a prompt that the course is about to end is sent; returning to Step S506.

In the embodiment of the present application, when an online student studies online, a live stream needs to be created, and when the live stream is created, the start time and the end time of the live stream will be scheduled. Thus, regardless of whether or not the course has been played, it is limited by the scheduled end time of the live stream, and the live stream will be automatically ended when the end time comes.

Likewise, in the case where the live stream is not ended, even if the start time of the next scheduled live stream has come, the next live stream will be canceled directly instead of starting directly.

There are two ways to create a live stream, one is a live stream created by an online student and the other is a live stream created by an online student's appointment, in either case the live stream can be ended in the following manner.

After the online student opens a course link, the live course can be started by directly clicking on the “Start Course” button. When ending a live stream, it can be done in two ways: one is that the teacher manually clicks on the “End” button to immediately end the live stream; the other is to enable the function of “Automatically Ending Live Stream”. In the process of a live stream, if the cameras (for example, 2 cameras) neither recognize a face nor detect a sound (voice) for a continuous period of time (which can be set), a pop-up window will be sent to prompt to select to end the live stream immediately or continue the course. If no operation is performed during the display of the pop-up window, then the live stream will be automatically closed and ended after 15 minutes.

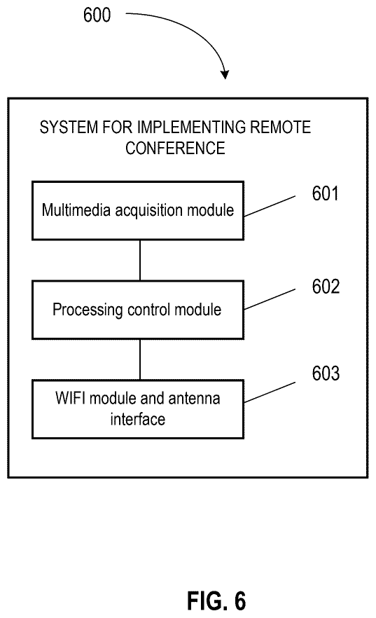

The system for implementing remote conference of the present application is described below with reference to FIG. 6, which illustrates a schematic flow chart of a system for implementing remote conference 600 according to an embodiment of the present application.
The system comprises: a multimedia acquisition module 601, a processing control module 602, and a WIFI module and an antenna interface 603 which are arranged integrally and locally;
The multimedia module 601 is configured to collect a first multimedia signal both on-site and from remote in real time and transmit the first multimedia signal to the processing control module 602, wherein the first multimedia signal both on-site and from remote at least comprises a video signal of the live streamer's courseware, a video signal of the live streamer's teaching image, an audio signal of the live streamer and a video signal of the image of on-site students;
The WIFI module and the antenna interface 603 are configured to connect to a wireless controller for receiving an operation instruction transmitted from the wireless controller and sending the operation instruction to the processing control module 602;
The processing control module 602 is configured to receive and process the first multimedia signal to obtain a second multimedia signal, and send the processed second multimedia signal to the multimedia module; and
The multimedia module 601 further comprises at least one set of multimedia output interfaces, configured to connect to, and transmit the processed second multimedia signal received from the processing control module 602 to, a multimedia display device arranged locally and/or remotely for display.

Wherein, the processing control module 602 is configured to:
when the remote conference is in the mode of live streamer only, collect an image video signal of the live streamer and an audio information of the live streamer and send them to a remote output device for output after processing;
when the remote conference is in the mode of live streamer plus shared content, collect and process the image video signal of the live streamer, a video information of the teaching content and the audio information of the live streamer; transmit the video information of the teaching content to a local display device for display; and send the processed image video information of the live streamer, the processed video information of the teaching content and the processed audio information of the live streamer to a remote output device for output.

The system for implementing remote conference according to an embodiment of the present application has an extended control feature, which allows the control of a third-party product (such as a video processor, an audio processor, a video matrix, a video switcher, a video splicer, smart home appliances and other IoT devices) via a teacher-controlled device and receives a feedback signal.

The system for implementing remote conference according to an embodiment of the present application supports access and control of a microphone, a camera, a control panel (teaching control device), a teaching screen, a head-up display, a keyboard, a mouse, and a laser pointer with remote control. It also supports the real-time view of the live courses of the teacher by remote students online, and the display of different teaching screen content according to different devices and roles, and has such advantages as IoT device interface, small footprint, low energy consumption, high cross-platform compatibility and high utilization of hardware resources.

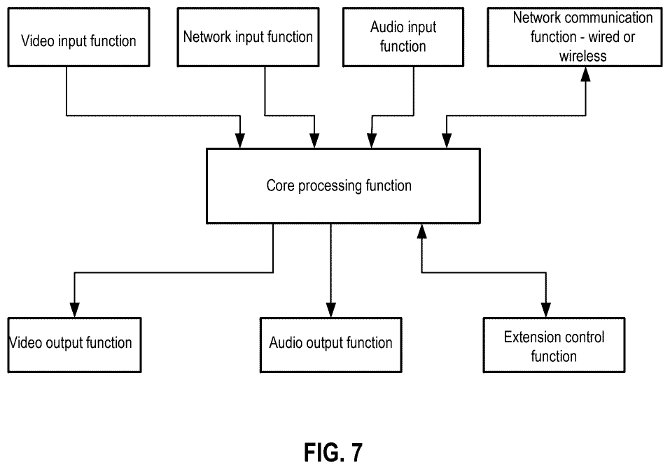

As shown in FIG. 7, this is a schematic diagram of an application scenario of a system for implementing remote conference according to an embodiment of the present application.

The input terminal of the system for implementing remote conference of the embodiment of the present application is connected to a video input function interface, a network input function interface, an audio input function interface and a network communication function interface (a wired or wireless connection mode), allowing a file which is received via any of the said interfaces to be sent to an output terminal after being processed by a core processing function module. The output terminal comprises a video output function interface, an audio output function interface and an extension control function interface.

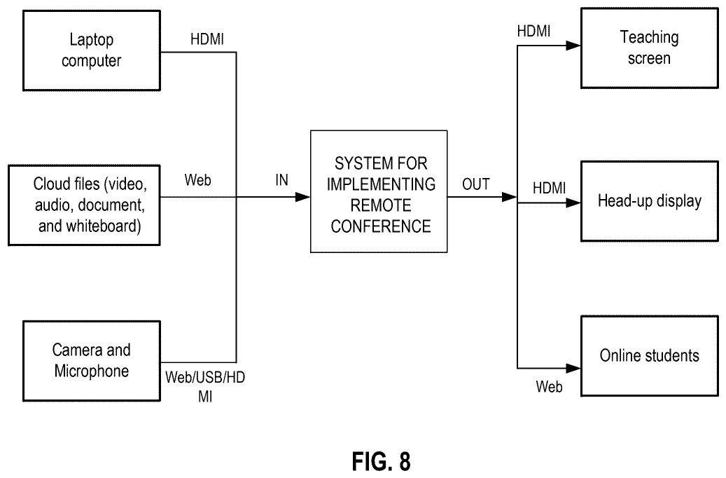

As shown in FIG. 8, this is a schematic diagram of another application scenario of a system for implementing remote conference according to an embodiment of the present application. In FIG. 8, the input terminal (IN) of the system for implementing remote conference is connected to a teacher's laptop computer through HDMI interface, and connected to a cloud server through network interface (such as RJ45) to obtain cloud files (such as video, audio, document, and whiteboard), and connected to an audio and video acquisition device such as a camera and a microphone through network interface. The output terminal (OUT) of the system for implementing remote conference is connected to the teaching screen and the head-up display through HDMI interface, and connected to the remote display device through network interface (such as RJ45) for online students to learn.

Further, according to an embodiment of the present application, there is provided a storage medium, having stored thereon program instructions, which, when executed by a computer or processor, will perform the corresponding steps of the method for implementing remote conference as described in the embodiments of the present application. The storage medium may be, for example, a memory card of a smart phone, a storage part of a tablet computer, a hard disk of a personal computer, a read-only memory (ROM), an erasable programmable read-only memory (EPROM), a portable compact disk read-only memory (CD-ROM), a USB memory, or any combination thereof.

The system for implementing remote conference and the storage medium of the embodiments of the present application have the same advantages as the method for implementing remote conference discussed above because it can realize the said method for implementing remote conference.

Although exemplary embodiments have been described herein with reference to the accompanying drawings, it is to be understood that the above-described exemplary embodiments are merely illustrative and are not intended to limit the scope of the present application. Numerous changes and modifications can be made therein by one of ordinary skill in the art without departing from the scope and spirit of the present application. All such changes and modifications are intended to be included within the scope of the present application as defined by the appended claims.

Those of ordinary skill in the art would recognize that the various illustrative units and algorithm steps described in connection with the embodiments disclosed herein may be implemented as electronic hardware, computer software, or combinations of both. Whether such functionality is implemented as hardware or software depends upon the particular application and design constraints imposed on the technical solution. Skilled artisans may implement the described functionality in varying ways for each particular application, but such implementation decisions should not be interpreted as causing a departure from the scope of the present application.

In the several embodiments provided herein, it should be understood that the disclosed apparatus and methods may be implemented in other ways. For example, the apparatus embodiments described above are only illustrative. For example, the division of the units is only a logical function division, and there may be other divisions in actual implementation, for example, a plurality of units or components may be combined or may be integrated into another system, or some features may be ignored or not implemented.

In the description provided herein, numerous specific details are set forth. However, it is understood that embodiments of the present application may be practiced without these specific details. In other instances, well-known methods, structures and techniques have not been shown in detail in order not to obscure the understanding of this description.

Similarly, it should be appreciated that in the description of exemplary embodiments of the present application, various features of the invention are sometimes grouped together in a single embodiment, figure, or description thereof for the purpose of streamlining the present application and aiding in the understanding of one or more of the various inventive aspects. This method of disclosure, however, is not to be interpreted as reflecting an intention that the claimed application requires more features than are expressly recited in each claim. Rather, as the following claims reflect, inventive aspects lie in less than all features of a single disclosed embodiment that may be implemented to solve a corresponding technical problem. Thus, the claims following the detailed description are hereby expressly incorporated into this detailed description, with each claim standing on its own as a separate embodiment of this invention.

It will be understood by those skilled in the art that all of the features disclosed in this specification (including the accompanying claims, abstract and drawings), and all of the processes or elements of any method or apparatus so disclosed, may be combined in any combination, except combinations where some of such features are mutually exclusive. Each feature disclosed in this specification (including any accompanying claims, abstract and drawings) may be replaced by alternative features serving the same, equivalent or similar purpose, unless expressly stated otherwise.

Furthermore, while some embodiments described herein include some but not other features included in other embodiments, combinations of features of different embodiments are meant to be within the scope of the present application, and form different embodiments, as would be understood by those skilled in the art. For example, in the claims, any one of the claimed embodiments may be used in any combination.

Various component embodiments of the present application may be implemented in hardware, or as software modules running on one or more processors, or on a combination thereof. That is, those skilled in the art will appreciate that a microprocessor or digital signal processor (DSP) may be used in practice to implement some or all of the functionality of some of the modules in embodiments of the present application. The present application may also be embodied as apparatus programs (e.g. computer programs and computer program products) for carrying out part or all of any of the methods described herein. Such programs embodying the present application may be stored on a computer-readable medium, or may be in the form of one or more signals. Such signals may be data signals downloadable from an Internet website, or provided on a carrier signal, or in any other form.

It should be noted that the above-mentioned embodiments illustrate rather than limit the present application, and that those skilled in the art will be able to design alternative embodiments without departing from the scope of the appended claims. In the claims, any reference signs placed between parentheses shall not be construed as limiting the claim. The word “comprising” does not exclude the presence of elements or steps other than those listed in a claim. The word “a”, “an” or “one” preceding an element does not exclude the presence of a plurality of such elements. The present application may be implemented by means of hardware comprising several distinct elements, and/or by means of a suitably programmed processor. In the unit claim enumerating several means, several of these means may be embodied by one and the same item of hardware. The terms “first”, “second”, “third” and the like are not necessarily used herein to connote a specific order, and may be interpreted as names.

What has been described above is merely preferred embodiments or a description of the embodiments of the present application, and is not intended to limit the scope of the present application. Any modifications and substitutions that could be easily made by a person skilled in the art within the scope of the technology disclosed herein, should be within the scope of the present application. The scope of protection of the present application shall be determined by the claims.

1. A method for implementing remote conference, characterized in that the method comprises:
when the remote conference is in the mode of live streamer only, collecting an image video signal of the live streamer and an audio information of the live streamer and sending them to a remote output device for output after processing;
when the remote conference is in the mode of live streamer plus shared content, collecting and processing the image video information of the live streamer, a video information of the live stream content and the audio information of the live streamer; transmitting the video information of the live stream content to a local display device for display; and sending the processed image video information of the live streamer, the processed video information of the live stream content and the processed audio information of the live streamer to a remote output device for output.

2. The method of claim 1, characterized in that the method further comprises:
when the remote conference is in the mode of live streamer plus shared content, the step of collecting and processing the image video information of the live streamer comprises: when the image video signal of the live streamer contains a close-up image of the live streamer, obtaining the close-up image video signal of the live streamer as the processed image video signal of the live streamer; when the image video signal of the live streamer contains an image but no close-up image of the live streamer, taking the image video signal of the live streamer as the processed image video signal of the live streamer.

3. The method of claim 1, characterized in that the method further comprises:
when the remote conference is in the mode of live streamer only, the step of collecting and analyzing the image video information of the live streamer comprises: when there is no portrait image in the image video of the live streamer, sending a default image to replace the image video of the live streamer;
when the remote conference is in the mode of live streamer plus shared content, the step of collecting and analyzing the image video information of the live streamer comprises: when there is no portrait image in the image video of the live streamer, sending a default content to replace the image video of the live streamer.

4. The method of claim 1, characterized in that the method further comprises:
recording the conference video displayed at the remote end in real time, and sending the recorded conference video to a cloud server for storage.

5. The method of claim 1, characterized in that the method further comprises:
when the switching condition is satisfied, switching the remote conference mode to a mode corresponding to the switching condition.

6. The method of claim 5, characterized in that the remote conference mode further comprises an interaction mode, and when the condition for the interaction mode is satisfied, a remote participant can interact with the live streamer.

7. The method of claim 1, characterized in that the method further comprises:
when receiving a request for creating a live stream sent by a participant, responding to the request;
when the condition for ending a remote conference is satisfied, ending the current remote conference;
wherein, the condition for ending a course comprises coming to a scheduled end time of live stream or receiving a course ending instruction.

8. The method of claim 1, characterized in that the method further comprises:
based on the settings of the local playing device and the remote playing device, the collected original audio signal of the remote conference is converted into target language subtitles and displayed.

9. A system for implementing remote conference, characterized in that the system comprises: a multimedia acquisition module, a processing control module, and a WIFI module and an antenna interface which are arranged integrally and locally;
the multimedia module is configured to collect a first multimedia signal both on-site and from remote in real time and transmit the first multimedia signal to the processing control module, wherein the first multimedia signal both on-site and from remote at least comprises a video signal of the live streamer's courseware, a video signal of the live streamer's live stream image, an audio signal of the live streamer and a video signal of the image of on-site students;
the WIFI module and the antenna interface are configured to connect to a wireless controller for receiving an operation instruction transmitted from the wireless controller and sending the operation instruction to the processing control module;
the processing control module is configured to receive and process the first multimedia signal to obtain a second multimedia signal, and send the processed second multimedia signal to the multimedia module; and
the multimedia module further comprises at least one set of multimedia output interfaces, configured to connect to, and transmit the processed second multimedia signal received from the processing control module to, a multimedia display device arranged locally and/or remotely for display;
wherein, the processing control module is configured to:
when the remote conference is in the mode of live streamer only, collecting an image video signal of the live streamer and an audio information of the live streamer and sending them to a remote output device for output after processing;
when the remote conference is in the mode of live streamer plus shared content, collect and process the image video signal of the live streamer, a video information of the live stream content and the audio information of the live streamer; transmit the video information of the live stream content to a local display device for display; and send the processed image video information of the live streamer, the processed video information of the live stream content and the processed audio information of the live streamer to a remote output device for output.

10. A storage medium, characterized in that, having stored thereon a computer program, which, when executed by a processor, causes the processor to carry out the method for implementing remote conference as defined in claim 1.
